(19) United States
(12) Patent Application Publication
(10) Pub. No.: US 2025/0308185 A1
(43) Pub. Date: Oct. 2, 2025

(54) Renderable Scene Graphs

(71) Applicant: Apple Inc., Cupertino, CA (US)

(72) Inventors: Ashwin K. Vijay, Sunnyvale, CA (US); Abhishek Bisht, Fremont, CA (US); Travis W. Brown, Boulder, CO (US)

(21) Appl. No.: 19/087,222

(22) Filed: Mar. 21, 2025

Related U.S. Application Data
(60) Provisional application No. 63/571,758, filed on Mar. 29, 2024.

(51) Int. Cl. G06T 19/20; G06T 17/00

(52) U.S. Cl. CPC G06T 19/20; G06T 17/005; G06T 2200/24; G06T 2210/61; G06T 2219/2021

(57) ABSTRACT

Devices, methods, and non-transitory computer-readable media are disclosed for the generation/modification of renderable three-dimensional (3D) scene graphs, e.g., from captured input data. According to some embodiments, multi-layer renderable scene graphs are disclosed. A computer graphics generating system may determine and/or infer the particular components that are needed to generate a requested 3D virtual environment on a device. In some embodiments, the system may also decompose previously-captured media assets into components for a renderable 3D scene graph. In some embodiments, the rendering 3D scene graph may have multiple levels and may comprise a combination of components having parametric and/or non-parametric representations. In some embodiments, components of the 3D scene graph may be moved, replaced, or otherwise modified by user input (e.g., via textual input, voice input, multimedia file input, gestural input, gaze input, programmatic input, or even another scene graph file) and the system's semantic understanding of the 3D scene graph.

### TECHNICAL FIELD

This disclosure relates generally to the field of computer graphics. More particularly, but not by way of limitation, it relates to techniques for the generation and modification of renderable three-dimensional (3D) scene graphs, e.g., from captured input data.

### BACKGROUND

In general, a scene graph includes information regarding objects that are to be rendered in a scene, as well as the relationships between those objects. The rendered scene may be fully computer-generated (i.e., virtual) or may comprise a mixture of computer-generated 3D components and “real world” components in the same environment.

In some implementations, a scene graph may be generated, at least in part, using an object relationship estimation model. For example, object nodes in the scene graph may correspond to “real-world” objects detected in an environment, such as tables, chairs, or the like, and/or to fully computer-generated or “virtual” 3D objects. Various nodes in the scene graph may be interconnected to other nodes by positional relationship connections (or other types of connections). For example, a table node may be connected to a grassy field node via an edge (i.e., connection) that indicates that the table has a positional relationship of “on top of” the grassy field.

In some implementations, a fully 3D representation of a virtual, physical, or “mixed” (i.e., physical and virtual) environment is acquired (e.g., either programmatically or via in image capture device), and, thus, positions of objects within the 3D representation may be detected and/or specified during the creation of the scene graph. Subsequently, a refined or modified 3D representation of the scene may be created utilizing the scene graph and one or more rules, user inputs, functions, and/or artificial intelligence (AI)- or machine learning (ML)-based models associated with the scene graph. For example, over time, such models may learn where certain components should logically appear in a fully (or partially) computer-generated scene (or where a user prefers such components to appear), i.e., relative to the other physical or virtual components that are a part of the scene graph.

A 3D representation may represent the 3D geometries of computer-generated and/or “real-world” objects by using a mesh, point cloud, signed distance field (SDF), or any other desired data structure. The data structure may include semantic information (e.g., a semantic mesh, a semantic point cloud, etc.) identifying semantic labels for data elements (e.g., semantically-labelled mesh points or mesh surfaces, semantically-labelled cloud points, etc.) that correspond to an object type, e.g., wall, floor, door, table, chair, cup, etc. The data structures and associated semantic information may be used to initially generate scene graphs.

However, there remains a desire to make the generation (and subsequent modification) of scene graphs, such as those representing renderable 3D environments, more streamlined, personalized, and flexible. By combining the use of language understanding models and generative AI-based models with existing scene graph and virtual environment creation tools, the techniques disclosed herein provide for more robust and performant virtual-reality and extended-reality environment creation systems.

### SUMMARY

Devices, methods, and non-transitory computer-readable media (CRM) are disclosed herein to: obtain a first input, e.g., via a user interface or programmatic interface, regarding one or more requested attributes of a three-dimensional (3D) graphical scene; parse the one or more requested attributes from the first input to determine one or more 3D components to add to a renderable 3D scene graph; add the determined one or more 3D components to the renderable 3D scene graph; and render the renderable 3D scene graph to the user interface of a device from a first viewpoint.

According to some embodiments, the first input may comprise one or more of: a textual input; a voice input; an image input; a gesture input; a gaze input; a programmatic input; a scene graph file; or a multimedia file input.

According to other embodiments, the techniques may further comprise: obtaining a second input regarding one or more requested modifications to the 3D graphical scene; parsing the one or more requested modifications from the second input to determine one or more modifications to at least one 3D component in the renderable 3D scene graph; modifying the at least one 3D component in the renderable 3D scene graph according to the determined one or more modifications to update the renderable 3D scene graph; and then re-rendering the updated renderable 3D scene graph to the user interface of the device.

According to other embodiments, the second input may comprises one or more of: a textual input; a voice input; an image input; a gesture input; a gaze input; a programmatic input; a scene graph file; or a multimedia file input.

According to other embodiments, the techniques may further comprise: parsing the one or more requested attributes from the first input to determine positions within the renderable 3D scene graph wherein one or more 3D components should be added.

According to some such embodiments, adding the determined one or more 3D components to the renderable 3D scene graph further comprises adding the determined one or more 3D components to the renderable 3D scene graph according to the determined positions for the one or more 3D components.

According to other embodiments, the first input comprises one or more multimedia assets from a multimedia library (e.g., a multimedia library of a user associated with the device), and wherein the one or more 3D components added to the renderable scene graph are determined based on content identified within the one or more multimedia assets.

According to still other embodiments, the one or more requested modifications to the 3D graphical scene directly identify the at least one 3D component in the renderable 3D scene graph to which the one or more determined modifications are made.

According to yet other embodiments, the parsing the one or more requested attributes from the first input to determine one or more 3D components to add to a renderable 3D scene graph further comprises parsing the one or more requested attributes from the first input using a trained machine learning (ML)- or artificial intelligence (AI)-based model, e.g., wherein the trained ML- or AI-based model may be configured to be updated over time based, at least in part, on user input to the user interface. According to some such embodiments, one or more ML- and/or AI-based generative models (or other functions) may also be used to generate and/or modify, at least in part, the determined 3D components for the renderable 3D scene graph.

According to further embodiments, at least one of the one or more 3D components added to the renderable 3D scene graph comprises a parametric representation of a graphical component (e.g., a neural radiance field (NeRF), Gaussian splat, or the like), and at least one of the one or more 3D components added to the renderable 3D scene graph comprises a non-parametric representation of a graphical component (e.g., a component composed from traditional 3D meshes and material textures, or the like).

Various non-transitory computer-readable media (CRM) embodiments are also disclosed herein. Such CRM are readable by one or more processors. Instructions may be stored on the CRM for causing the one or more processors to perform any of the embodiments disclosed herein. Various electronic devices are also disclosed herein, e.g., comprising memory, one or more processors, image capture devices, displays, user interfaces, and/or other electronic components, and programmed to perform in accordance with the various method and CRM embodiments disclosed herein.

### BRIEF DESCRIPTION OF THE DRAWINGS

FIGS. 1A-1B illustrate examples of a renderable three-dimensional (3D) scene graph, according to one or more embodiments.

FIGS. 1C-1D illustrate examples of a modified renderable 3D scene graph, according to one or more embodiments.

FIGS. 1E-1F illustrate examples of adding a component to a renderable 3D scene graph, according to one or more embodiments.

FIG. 1G illustrates an example of adding a renderable 3D scene graph to a virtual or extended reality (XR) environment, according to one or more embodiments.

FIG. 2 is a flow chart illustrating a method of creating and modifying renderable 3D scene graphs, according to various embodiments.

FIG. 3 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

The techniques disclosed herein relate generally to devices, methods, and non-transitory computer-readable media for the generation (and modification) of renderable three-dimensional (3D) scene graphs, e.g., from captured input data. According to some embodiments, multi-layer renderable scene graphs are disclosed. A computer graphics generating system may determine and/or infer the particular components that are needed to generate a requested 3D virtual environment on a device.

In some embodiments, the system may also decompose previously-captured media assets into components for a renderable 3D scene graph. In some embodiments, the rendering 3D scene graph may have multiple levels and may comprise a combination of components having parametric and/or non-parametric representations. In some embodiments, components of the 3D scene graph may be moved, replaced, or otherwise modified by user input (e.g., via textual input, voice input, multimedia file input, gestural input, gaze input, programmatic input, or even another scene graph file)-in addition to the system's semantic understanding of the 3D scene graph.

### Exemplary Renderable Three-Dimensional (3D) Scene Graphs

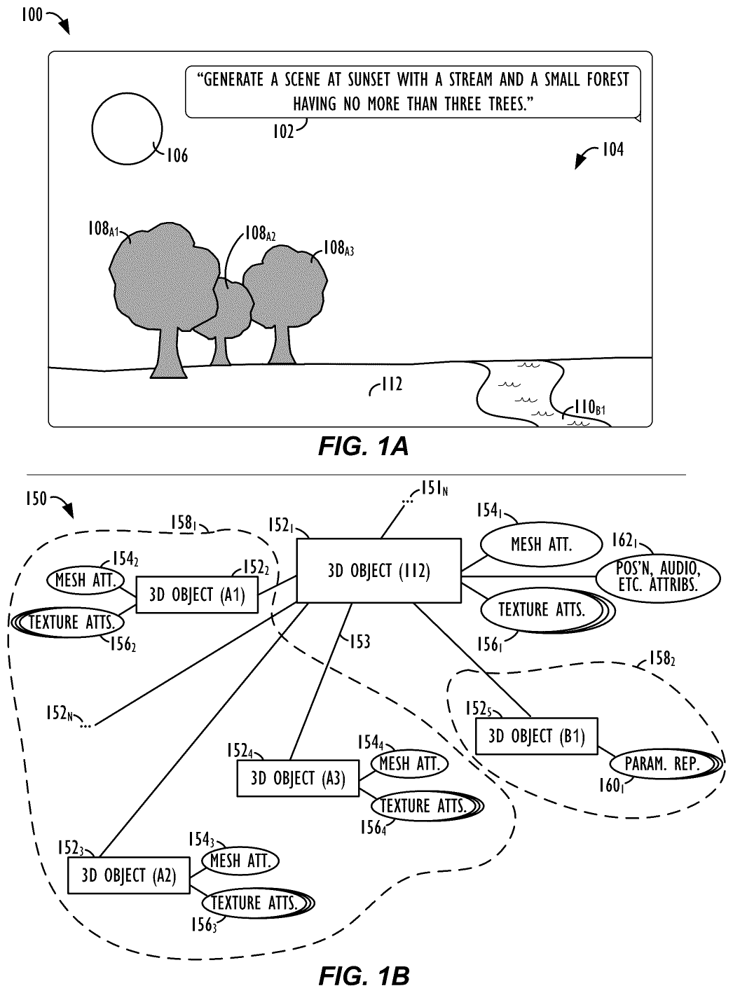

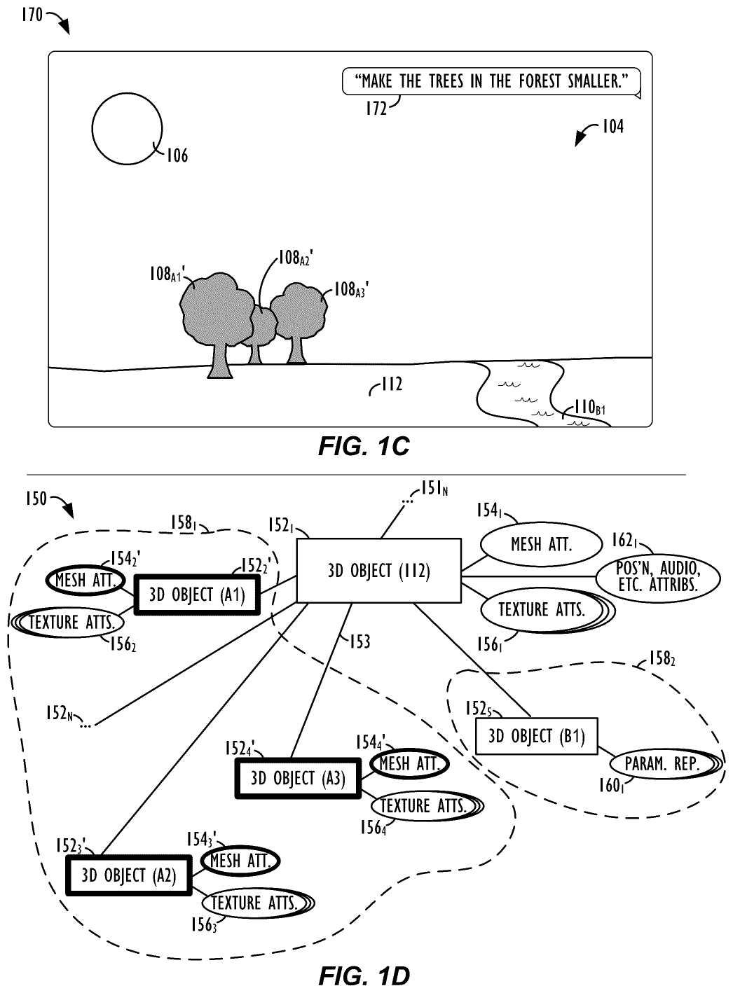

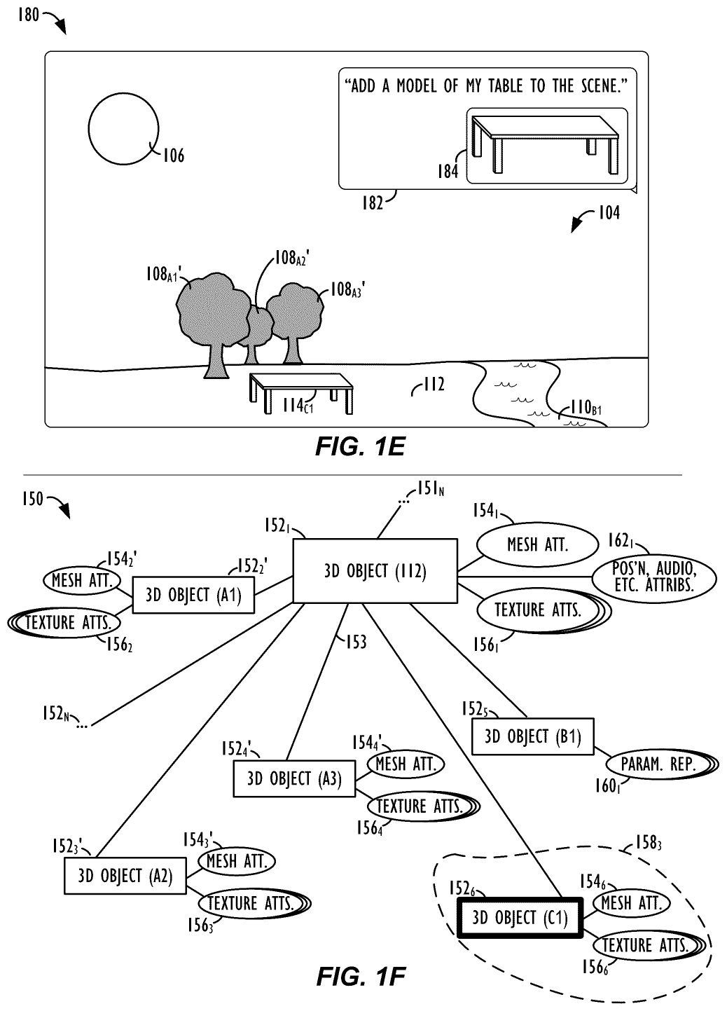

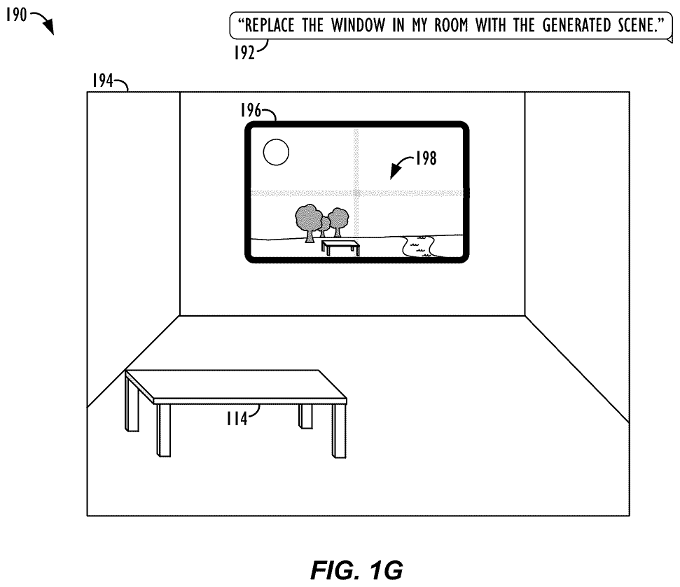

Turning first to FIGS. 1A-1B, examples of a renderable three-dimensional (3D) scene graph 150 are illustrated, according to one or more embodiments. In the example of FIG. 1A, an editing/development session for a virtual/3D environment may begin by the system obtaining a first user input, such as a voice- or text-based prompt 102 from a user, which, in this example, states: “Generate a scene at sunset with a stream and a small forest having no more than three trees.” As may be understood, prompts, as used herein, may include any natural language (or multimedia-based) description of a desired environment, e.g., reciting particular objects or types of objects desired in the scene (e.g., one table and two chairs), desired scene-level descriptions (e.g., a tropical rainforest), seasons, types of weather, times of day, etc.

Next, through the use of various functions and/or models (e.g., Natural Language Processing (NLP) or other semantic language understanding models), the prompt 102 may be parsed to determine particular 3D components that should be generated (and/or modified) for a renderable 3D scene graph in order to comply with the input prompt 102. In this example, the system may determine that three 3D tree objects (108_{A1}, 108_{A2}, and 108_{A3}), a stream object (110_{B1}), a grassy field (112), and a sun object (106) (and, possibly, many additional objects, meshes, textures, etc.) should be generated to meet prompt 102.

In addition to the various 3D graphical components, meshes, textures, etc., that are generated and inserted into a renderable 3D scene graph, the system may also determine or infer various sizes, locations, and relative spatial positionings for the generated components in the virtual scene. For example, in illustrative virtual scene 104 of FIG. 1A, the system has determined that the three tree objects (108_{A1}, 108_{A2}, and 108_{A3}) are roughly medium-sized, grouped together, and positioned at the left-side of the virtual scene 104 (i.e., at the particular viewpoint 100 that is illustrated in FIG. 1A). Similarly, the system has determined that the sun object 106 is setting behind the tree objects, and that the stream object 110_{B1} is located to the right of the small forest and placed on the same plane as the grassy field object 112.

It is to be understood that this initial positioning of objects within the virtual scene is merely illustrative. As will be explained in further detail below, a user may subsequently reposition, add, remove, or modify any modifiable characteristic of any of the 3D components included in the renderable 3D scene graph, e.g., via a subsequent user input. In fact, in some embodiments, a generated object may even be changed from being represented as a 3D component into being represented as a 2D component, e.g., based on its depth in the scene. For example, as an object is moved farther and farther away in the virtual environment from the user's current viewpoint, there may no longer be a need to represent it as a fully 3D component in the scene graph, and processing resources may be saved by intelligently converting the object into a 2D representation when positioned at depths beyond a threshold scene depth.

Turning next to FIG. 1B, an exemplary renderable 3D scene graph 150 is shown that represents at least a portion of the virtual scene 104 illustrated in FIG. 1A. In particular, the scene graph 150 may comprise a virtual 3D object 152₁ that is representative of the grassy field object 112 from virtual scene 104 illustrated in FIG. 1A. Each object in the scene graph 150 may have various characteristics or attributes. For example, in the case of virtual 3D object 152₁, it may have a 3D mesh attribute (154₁), one or more texture attributes (156₁) that may be applied to the grassy field object 112, as well as various other characteristics (162₁), such a position, audio characteristics (e.g., certain “virtual” materials in the scene may have certain acoustic reflectance characteristics that the user may want represented in the virtual environment and/or certain objects may serve as audio “sources” for sounds that the user wants to be able to hear in the virtual environment as emanating from the object, etc.), physical characteristics, as well any additional user-defined characteristics.

As further illustrated in scene graph 150, each object in the scene graph may have one or more relationships (e.g., as illustrated by exemplary edges 153) to one or more other objects in the scene graph. According to some embodiments, these relationships may also have particular attributes or types (e.g., “is a part of,” or “contains,” or “is on top of,” and so forth) that further specify an interrelationship between any to objects in the virtual scene. As one example, the three tree objects (108_{A1}, 108_{A2}, and 108_{A3}) may each have an “is on top of” relationship/edge with the grassy field object 112. Thus, when rendering the virtual scene, the renderer will know to place the tree objects on top of the grassy field object, such that, if the grassy field object is later repositioned, the trees will maintain their “is on top of” relationship to the grassy field object.

As is also illustrated in scene graph 150, a particular object, such as object 152₁, may have relationships with various objects that are “higher” in the scene graph hierarchy (e.g., 151N), as well as any number of objects that are “lower” in the scene graph hierarchy (e.g., 152N).

Similar to the description of object 152₁, above, the three tree objects (108_{A1}, 108_{A2}, and 108_{A3}) may also be represented in scene graph 150, e.g., as a grouping of components (158₁), comprising: virtual 3D object 152₂ (i.e., representing tree 108_{A1}), having a 3D mesh attribute (154₂) and one or more texture attributes (156₂); virtual 3D object 152₃ (i.e., representing tree 108_{A2}), having a 3D mesh attribute (154₃) and one or more texture attributes (156₃); and virtual 3D object 152₄ (i.e., representing tree 108_{A3}), having a 3D mesh attribute (154₄) and one or more texture attributes (156₄). Other objects, e.g., virtual 3D object 152₅ (i.e., representing the stream object 110_{B1}), may also be represented in scene graph 150 (e.g., as part of another group of components 158₂), and may have other types of attributes, such as a parametric representation (160₁) (e.g., a NeRF representation or Gaussian splat, etc.), rather than a traditional mesh/texture, i.e., non-parametric, representation.

According to some embodiments, a user may, at an individual 3D object/component level, choose to use a trained network to perform some or all of the object generation (e.g., the user specifying a types of material or texture to use for a component via an image, while allowing the rest of the attributes of the component to be inferred by the trained network).

It is to be understood that the various objects and attributes illustrated in scene graph 150 are merely exemplary, and any of the aforementioned attributes or characteristics may be modified either automatically/programmatically, or via explicit user input, and that modifications to the components represented in scene graph 150 may result in a different rendering of the corresponding virtual scene 104, such as is illustrated in FIG. 1A.

Turning next to FIGS. 1C-1D, examples of a modified renderable 3D scene graph 150 are illustrated, according to one or more embodiments. As shown in FIG. 1C, a second input has been received by the system, in the form of a voice- or text-based prompt 172 from a user, which, in this example, states: “Make the trees in the forest smaller.” Then, in response to the second input, and, e.g., using various functions and/or models (e.g., NLP or other semantic language understanding models), the prompt 172 may be parsed to determine particular 3D components that should be modified within scene graph 150 in order to comply with the input prompt 172. In this example, the system may determine that the three 3D tree objects (108_{A1}, 108_{A2}, and 108_{A3}) should be modified in response to prompt 172 and, in particular, that their respective meshes (i.e., 154₂, 154₃, and 154₄) should be reduced in size to make them “smaller.” In some embodiments, the component to be modified may be directly and/or uniquely identified by a user (e.g., “the sun”), e.g., via a textual input, a voice input, a gesture input, a gaze input, a programmatic input, or the like, which results in the system editing the underlying scene graph object itself (e.g., the node in the scene graph representing the sun), rather than the underlying pixels representing the sun in the image that reflects the user's current viewpoint.

According to some implementations, the system may further comprise a model that learns over time what is meant by relative descriptive terms (e.g., smaller, larger, brighter, darker, happier, etc.) and thus generate or modify 3D components that it predicts will mostly likely satisfy the particular input prompt. In other implementations, default or modifiable parameters may be used, e.g., using size/color/positioning increments of 10% at a time, or the like. Of course, any initial modifications to components in the scene graph as determined by the system may subsequently be modified to the particular user's liking.

As shown in FIG. 1D, in response to the prompt 172, the mesh attributes 154₂, 154₃, and 154₄ of tree objects 152₂, 152₃, and 152₄, respectively, have been modified (i.e., to decrease their size), as reflected in their updated element numbering in FIG. 1D of: 154₂′, 154₃′, 154₄′, 152₂′, 152₃′, and 152₄′. Similarly, the appearance of the tree objects in the updated viewpoint 170 of virtual scene 104 of FIG. 1C have been updated to be made smaller, and they have been given updated element numbering of: 108_{A1}′, 108_{A2}′, and 108_{A3}′.

Turning next to FIGS. 1E-1F, examples of adding a component to a renderable 3D scene graph 150 are illustrated, according to one or more embodiments. As shown in FIG. 1E, a third input has been received by the system, in the form of a voice- or text-based prompt 182 from a user, which, in this example, states: “Add a model of my table to the scene,” and includes a representation of the user's table 184 (which representation could be, e.g., a two-dimensional (2D) image of the user's table or an actual 3D mesh/model of the user's table, or an AI-generated 3D model of the requested component, etc.). In response to the third input, and, e.g., using various functions and/or models (e.g., NLP or other semantic language understanding models), the prompt 182 may be parsed to determine a particular 3D component that should be added to scene graph 150 to represent the user's table 184 and comply with the input prompt 182.

It is to be understood that, in some embodiments, the input may comprise a multimedia asset from a multimedia library of a user associated with the device (e.g., a photo of the user's own table, own apartment, etc., from the user's multimedia library) or from some other multimedia library that the user may have access to (e.g., a photo of the Eiffel Tower in Paris, or other landmarks, etc.). In some embodiments, the system itself may analyze the multimedia content and suggest additional content sources for the user to select from for inclusion into the scene graph.

In other embodiments, some or all of components that are referred to or requested in an exemplary prompt 182 may be generated ‘on-the-fly,’ e.g., by leveraging the output of AI-based generative models. In some such embodiments, the scene rendering system's UI may have a designated area(s), e.g., prompt area 182 in the example of FIG. 1E or any other designated area in the system's UI, wherein the user of the system can see the results of their prompts (e.g., if they use a generative prompt) and the overall effect that their prompt will have on the virtual scene 104 (e.g., the generation of a new component, the modification of existing components, etc.), such that the user can make any further desired modifications, or cancel the prompted generative request, etc., before officially confirming the results of the generative prompt and updating the virtual scene 104 with the newly-generated components and/or modifications created in response to the generative prompt.

In still other embodiments, the components of the virtual scene 104 may be programmed to have one or more time-dependent aspects to their appearance (e.g., having one or more properties that change over a duration of time, loop over a duration of time, synchronize with real-world timing/weather conditions over a duration of time, etc.). One example would be a renderable 3D scene graph that changes from a “daytime” appearance to a “nighttime” appearance over the span of a determined number of hours (e.g., diminishing/removing the appearance and effects of sun object 106 over the duration of time, gradually decreasing the brightness levels of the virtual scene over the duration of time, inserting new components, e.g., the Moon and/or various stars, at varying points over the duration of time, etc.). In some such embodiments, a user may also be able to “scrub” through a video preview version of the rendering of the virtual scene 104 over the duration of time, e.g., to determine if the generated time-dependent animations/changes to the virtual scene are approved—or, instead, if further modification is desired before accepting the proposed time-dependent animations to the virtual scene 104.

Returning now to the example shown in FIGS. 1E-1F, the system may determine that a new 3D table object (114_{C1}) should be generated in response to prompt 182 and added into scene graph 150 as a new component 152₆ (e.g., as part of another group of components 158₃), i.e., having a 3D mesh attribute (154₆) and one or more texture attributes (156₆), as well as a relationship to one or more other objects in the scene graph 150 (e.g., the table 114_{C1} may also be located “on top of” the grassy field object 112). As mentioned above, the system may use a model and/or prior learnings/preferences of the particular user to determine an initial relative positioning for table 114c1, e.g., it is shown in the updated viewpoint 180 of FIG. 1E as being located in front of the small forest composed of modified trees 108_{A1}′, 108_{A2}′, and 108_{A3}′.

As also mentioned above, any initial characteristics of components added to the scene graph as determined by the system may subsequently be modified to the particular user's liking. For example, in the case of the table 114_{C1}, the user may wish to resize or reposition the table, change the material(s) used for the table's textures, etc.—with the attendant modifications also being stored in the respective objects' attributes within the scene graph 150.

Turning now to FIG. 1G, an example of adding a renderable 3D scene graph to a virtual or XR environment is illustrated, according to one or more embodiments. As shown in FIG. 1G, a fourth input has been received by the system, in the form of a voice- or text-based prompt 192 from a user, which, in this example, states: “Replace the window in my room with the generated scene.” In response to the fourth input, and, e.g., using various functions and/or models (e.g., NLP or other semantic language understanding models), the prompt 192 may be parsed to determine that a user is asking for a representation of the generated virtual scene 104 (e.g., as last described with respect to the updated viewpoint 180 of FIG. 1E) to be projected onto the location a window in the room that the user is in.

It is to be understood that the example of FIG. 1G is depicting an XR or mixed reality environment, which may represent a user's viewpoint 190 (e.g., via a head mountable device (HMD) or other computing device) into a physical room 194 with a real window 196, and possibly other physical, real-word objects, such as the user's table 114 (which was mentioned in reference to previous FIGS. 1E-1F), as well as other virtual or computer-generated 3D components or content placed or projected into the environment.

Once the system has determined the semantic meanings of the terms in prompt 192, e.g., that “window” in the prompt 192 refers to window 196, that the “room” in the prompt 192 refers to room 194, etc., it may take the appropriate action and project/replace the generated virtual scene 104 (i.e., as represented by renderable scene graph 150) into the XR environment at the appropriate size, location, etc., according to the user's current viewpoint 190. This overlaid virtual scene is represented at 198 in FIG. 1G, i.e., the generated virtual scene 104 is projected into the user's XR environment at the size and location of identified “real-world” window 196, thereby replacing the view the user sees when looking out “real-world” window 196 with the viewpoint 180 of the generated virtual scene 104.

It is to be understood that FIG. 1G depicts just one example (i.e., window replacement) of a way in which a generated virtual scene could be included into and/or interact with a real-world environment. In other embodiments, the system may detect the window as a source of light, and, when the window is replaced, the system may further recalculate real-world scene lighting to present a realistic scene to the user.

### Exemplary Methods of Creating and Modifying Renderable 3D Scene Graphs

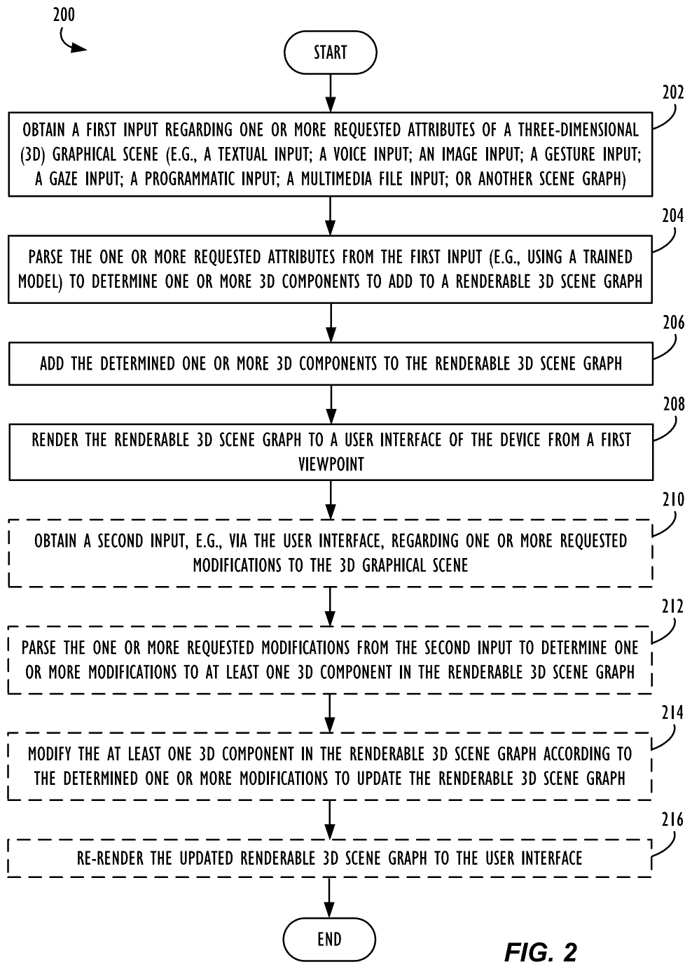

FIG. 2 is a flow chart, illustrating a method 200 of creating and modifying renderable 3D scene graphs, according to various embodiments. First, at Step 202, the method 200 may obtain, a first input regarding one or more requested attributes of a three-dimensional (3D) graphical scene (e.g., a textual input; a voice input; an image input; a gesture input; a gaze input; a programmatic input; a multimedia file input; or another scene graph).

Turning now to Step 204, the method 200 may parse the one or more requested attributes from the first input (e.g., using a trained AI- or ML-based model, or the like) to determine one or more 3D components to add to a renderable 3D scene graph. For example, returning to the example of FIG. 1A, parsing the sentence: “Generate a scene at sunset with a stream and a small forest having no more than three trees.” may result in the system delegating a task to a particular function or generative 3D model that is configured to generate trees or other plant-like objects to generate three (or more) trees of a particular (or randomized) tree type. The resulting generated 3D tree components could then be included in the renderable 3D scene graph that is being constructed by the system. In some embodiments, an initial positioning within the graphical scene for a particular component may also be inferred from the first input (e.g., the text of the first input may explicitly specify where to place a component, a gesture input may include a hand pointing to where in the scene to initially place a component, a user's gaze direction when providing the first input to the system may indicate where in the scene to initially place a component, etc.)

Turning now to Step 206, the method 200 may add the determined one or more 3D components to the renderable 3D scene graph and, at Step 208, render the renderable 3D scene graph to a user interface of the device from a first viewpoint. In some implementations, the system may also be configured to render multiple versions of a 3D scene graph based on the user's input, and then let the user selection which of the versions they would prefer to use.

Then, according to some embodiments, the method 200 may proceed to optional Step 210, wherein a second input may be obtained, e.g., via the user interface, regarding one or more requested modifications to the 3D graphical scene. (It is to be understood that the recitation in FIG. 2 of obtaining the first input for the purposes of adding/generating new 3D components and obtaining the second input for the purposes of modifying existing 3D components is purely illustrative, and that any number and/or sequence of user or programmatic inputs may be received by the system to add, delete, and/or modify any number of characteristics of components of the scene graph, as is desired.)

Next, at optional Step 212, the system may parse the one or more requested modifications from the second input at Step 210, i.e., to determine one or more modifications to at least one 3D component in the renderable 3D scene graph. Next, at optional Step 214, the system may modify the at least one 3D component in the renderable 3D scene graph according to the determined one or more modifications to update the renderable 3D scene graph. Finally, at optional Step 216, the system may re-render the updated renderable 3D scene graph to the user interface.

As may now be appreciated, by making modifications to an underlying model, i.e., rather than to individual pixels of a generated image or object, a user could manipulate individual 3D components and then later undo (or keep) as many of the modifications as the user desired. This provides the user with a greater detail of control over the generated graphical scene than traditional methods (and/or purely ML- or AI-based generative image models that are not subsequently editable, e.g., if some aspect of the generated content is not to the user's liking).

According to some embodiments, the scene model generation system may optimize the generated scene based on the expected rendering hardware capabilities and even provide performance heuristics.

The various methods described herein, e.g., with reference to FIG. 2, may be performed by a system or electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS (or calls to a different, e.g., paired, device entirely) to perform other steps in the method. Similarly, a device's OS can receive API calls from an App or elsewhere and process/perform the calls to cause the method to be performed by the device(s).

According to some embodiments, the scene rendering system may include a distributed computing architecture, e.g., involving both on-device and off-device rendering, as well as both offline and real-time rendering. For one example, in some implementations, world-scale, i.e., larger, textures may initially be generated at relatively lower resolutions by a cloud-computing device and then upscaled on the user's device when needed for display, thereby saving compute cycles for the user's device. As another example, one or more steps of the various methods described herein may be offloaded and performed by a server device external to a user's own device.

As may now be appreciated, the various methods described herein may be performed as part of a developer or artist tool to create virtual/3D graphical environments or games. In other words, the various methods described herein may provide a developer or artist with a fast and easy “head start” at developing a virtual/3D graphical environment, and then subsequent changes, modifications, customizations to the virtual/3D graphical environment may be made by the developer or artist in a software-based development program or development environment according to more traditional techniques.

According to some implementations, such development programs/environments may also possess ML- and/or AI-based tools to learn the developer and/or artist's preferences and/or techniques over time, such that the development program is able to suggest or automatically initiate the particular types of objects or features that the developer or artist is likely to want to employ at a given time or in a given context. For example, if an artist or development studio makes similar edits to generated 3D “tree” objects over time in order to reach a desired output, the generative models employed by the system could learn such techniques over time, so that future 3D “tree” objects are initially generated with characteristics closer to what the artist/studio typically uses or prefers.

According to other implementations, the scene rendering system could be constrained to choose from a particular set of components to use, e.g., from particular definitions or parametric representations of components, or from a library of available component assets, etc.

### Exemplary Electronic Computing Devices

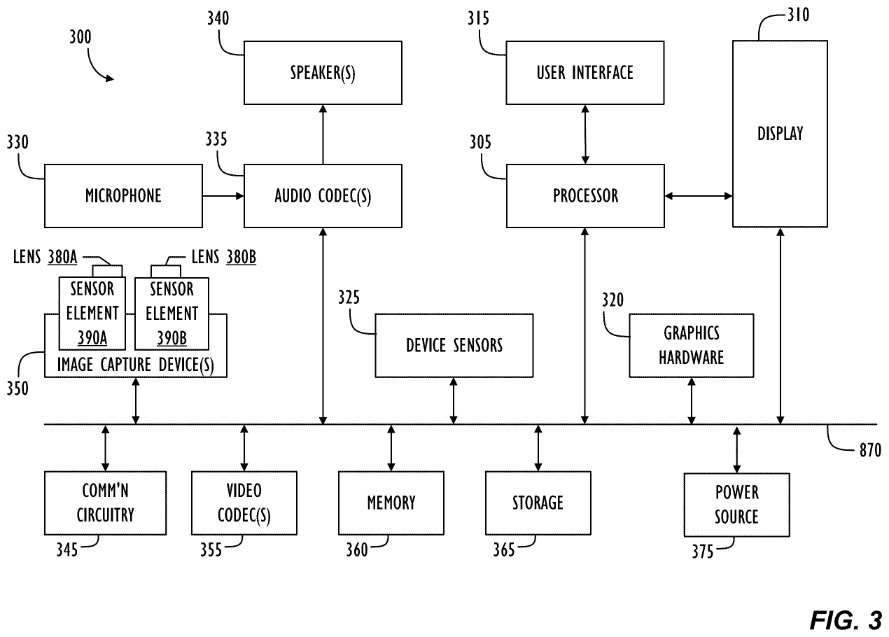

Referring now to FIG. 3, a simplified functional block diagram of illustrative programmable electronic computing device 300 is shown according to one embodiment. Electronic device 300 could be, for example, a mobile telephone, personal media device, portable camera, or a tablet, notebook or desktop computer system. As shown, electronic device 300 may include processor 305, display 310, user interface 315, graphics hardware 320, device sensors 325 (e.g., proximity sensor/ambient light sensor, accelerometer, inertial measurement unit, and/or gyroscope), microphone 330, audio codec(s) 335, speaker(s) 340, communications circuitry 345, image capture device 350, which may, e.g., comprise multiple camera units/optical image sensors having different characteristics or abilities (e.g., Still Image Stabilization (SIS), HDR, OIS systems, optical zoom, digital zoom, etc.), video codec(s) 355, memory 360, storage 365, and communications bus 370.

Processor 305 may execute instructions necessary to carry out or control the operation of many functions performed by electronic device 300 (e.g., such as the generation, processing, and/or modification of renderable 3D scene graphs, in accordance with the various embodiments described herein). Processor 305 may, for instance, drive display 310 and receive user input from user interface 315. As described above, processor 305 can perform one or more machine learning-based and/or non-machine-learning-based models for perceiving, synthesizing, and inferring information provided by a user in the generation and modification of renderable scene graphs. Persons skilled in the art will appreciate that the renderable scene graph generation process (e.g., 200) can include any suitable number of 3D component selection, generation, animation, and/or modification processes to generate renderable scene graph output based on user interface 315 input.

Persons of ordinary skill in the art will appreciate that renderable scene graph generation process 200 can include any suitable machine learning models that are well-known or widely available, such as neural networks, and deep learning networks. For instance, the renderable scene graph generation process 200 can include the use of neural networks, such as Artificial Neural Networks (ANN), Convolutional Neural Networks (CNN), Recurrent Neural Networks (RNN), Generative Adversarial Networks (GAN), Encoder/Decoder Networks and/or a multi-modal large language model (LLM) to interpret user prompts and generate or modify scene graph components. Additionally, or alternatively, persons of ordinary skill in the art will appreciate that the renderable scene graph generation process 200 can be also utilize any suitable non-machine-learning-based processes, such as rule-based systems, heuristics, decision trees, knowledge-based systems, statistical or stochastic systems, and/or traditional user interface selection and “drag and drop” types of tools.

In instances where the renderable scene graph generation process 200 leverages one or more machine-learning-based models, the renderable scene graph generation process 200 can be trained to interpret user prompts (e.g., using a LLM or multi-modal LLM) and then determine which one or more components will be generated (or modified) in the renderable scene graph, i.e., in an attempt to satisfy the user prompts, e.g., using any of the aforementioned types of machine-learning-based models or other generative models.

User interface 315 can take a variety of forms, such as a button, keypad, dial, a click wheel, keyboard, display screen and/or a touch screen. User interface 315 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 310 may display a video stream as it is captured while processor 305 and/or graphics hardware 320 and/or image capture circuitry contemporaneously generate and store the video stream in memory 360 and/or storage 365. Processor 305 may be a system-on-chip (SOC) such as those found in mobile devices and include one or more dedicated graphics processing units (GPUS). Processor 305 may be based on reduced instruction-set computer (RISC) or complex instruction-set computer (CISC) architectures or any other suitable architecture and may include one or more processing cores. Graphics hardware 320 may be special purpose computational hardware for processing graphics and/or assisting processor 305 perform computational tasks. In one embodiment, graphics hardware 320 may include one or more programmable graphics processing units (GPUS) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 350 may comprise one or more camera units configured to capture images, e.g., images which may be processed to generate cropped, augmented, and/or distortion-corrected versions of said captured images, e.g., in accordance with this disclosure. Image capture device(s) 350 may include two (or more) lens assemblies 380A and 380B, where each lens assembly may have a separate focal length. For example, lens assembly 380A may have a shorter focal length relative to the focal length of lens assembly 380B. Each lens assembly may have a separate associated sensor element, e.g., sensor elements 390A/390B. Alternatively, two or more lens assemblies may share a common sensor element. Image capture device(s) 350 may capture still and/or video images. Output from image capture device 350 may be processed, at least in part, by video codec(s) 355 and/or processor 305 and/or graphics hardware 320, and/or a dedicated image processing unit or image signal processor incorporated within image capture device 350. Images so captured may be stored in memory 360 and/or storage 365.

Memory 360 may include one or more different types of media used by processor 305, graphics hardware 320, and image capture device 350 to perform device functions. For example, memory 360 may include memory cache, read-only memory (ROM), and/or random access memory (RAM). Storage 365 may store media (e.g., audio, image and video files), computer program instructions or software, preference information, device profile information, and any other suitable data. Storage 365 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 360 and storage 365 may be used to retain computer program instructions or code organized into one or more modules and written in any desired computer programming language. When executed by, for example, processor 305, such computer program code may implement one or more of the methods or processes described herein. Power source 375 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 300.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the scene graph generation processes can be used to benefit users. For example, the data can be used to train models that can be deployed to improve performance, accuracy, and/or functionality of applications and/or services. Accordingly, the use of the data enables the scene graph generation processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the scene graph generation processes are also contemplated by the present disclosure.

The present disclosure contemplates that, in some embodiments, data used by the scene graph generation processes may include publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with the scene graph generation processes, should attempt to comply with well-established privacy policies and/or privacy practices.

For example, such entities may implement and consistently follow policies and practices recognized as meeting or exceeding industry standards and regulatory requirements for developing and/or training machine-learning-enabled processes. In doing so, attempts should be made to ensure all intellectual property rights and privacy considerations are maintained. Training should include practices safeguarding training data, such as personal information, through sufficient protections against misuse or exploitation. Such policies and practices should cover all stages of any generative model development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, the scene graph generation processes may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation, as may be done cryptographically by secret sharing data or other means so that the user data is not leaked to the other devices.

In some embodiments, a trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior (or preferences) of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for scene graph generation processes may be kept strictly separated from platforms where the scene graph generation processes are deployed and/or used to interact with users and/or process data. In such embodiments, data used for offline training of the scene graph generation processes may be maintained in secured datastores with restricted access and/or not be retained beyond the duration necessary for training purposes. In some embodiments, the scene graph generation processes may utilize a local memory cache to store data temporarily during a user session. The local memory cache may be used to improve performance of the scene graph generation processes. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the [technology descriptor] processes. The scene graph generation processes should be monitored for changes in underlying data distribution such as concept drift or data skew that can degrade performance of the processes over time.

In some embodiments, the scene graph generation processes are trained using a combination of offline and online training. Offline training can use curated datasets to establish baseline model performance, while online training can allow the scene graph generation processes to continually adapt and/or improve. The present disclosure recognizes the importance of maintaining strict data governance practices throughout this process to ensure user privacy is protected.

In some embodiments, the scene graph generation processes may be designed with safeguards to maintain adherence to originally intended purposes, even as the scene graph generation processes adapt based on new data. Any significant changes in data collection and/or applications of scene graph generation processes use may (and, in some cases, should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the scene graph generation processes and/or for use as input during the inference stage of such systems. In yet another example, the present technology should be configured to allow users to be able to select to limit the length of time data is maintained or entirely prohibit the use of their data for use by the scene graph generation processes. In addition to providing “opt in” and “opt out” options, the present disclosure contemplates providing notifications relating to the access or use of personal information. For instance, a user can be notified when their data is being input into the scene graph generation processes for training or inference purposes, and/or reminded when the scene graph generation processes generate outputs or make decisions based on their data.

The present disclosure recognizes scene graph generation processes should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the scene graph generation processes. Generated content can be filtered for potentially inappropriate or dangerous material prior to being presented to users, while human oversight and/or ability to override or correct erroneous or undesirable outputs can be maintained as a failsafe.

The present disclosure further contemplates that users of the scene graph generation processes should refrain from using the services in any manner that infringes upon, misappropriates, or violates the rights of any party. Furthermore, the scene graph generation processes should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The scene graph generation processes should not violate, misappropriate, or infringe any copyrights, trademarks, rights of privacy and publicity, trade secrets, patents, or other proprietary or legal rights of any party, and appropriately attribute content as required. Further, the scene graph generation processes should not interfere with any security, digital signing, digital rights management, content protection, verification, or authentication mechanisms. The scene graph generation processes should not misrepresent machine-generated outputs as being human-generated.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A device, comprising:
a memory;
a user interface; and
one or more processors operatively coupled to the memory, wherein the one or more processors are configured to execute instructions causing the one or more processors to:
obtain a first input regarding one or more requested attributes of a three-dimensional (3D) graphical scene;
parse the one or more requested attributes from the first input to determine one or more 3D components to add to a renderable 3D scene graph;
add the determined one or more 3D components to the renderable 3D scene graph; and
render the renderable 3D scene graph to the user interface of the device from a first viewpoint.

2. The device of claim 1, wherein the first input comprises one or more of: a textual input; a voice input; an image input; a gesture input; a gaze input; a programmatic input; a scene graph file; or a multimedia file input.

3. The device of claim 1, wherein the one or more processors are further configured to execute instructions causing the one or more processors to:
obtain a second input regarding one or more requested modifications to the 3D graphical scene;
parse the one or more requested modifications from the second input to determine one or more modifications to at least one 3D component in the renderable 3D scene graph;
modify the at least one 3D component in the renderable 3D scene graph according to the determined one or more modifications to update the renderable 3D scene graph; and
re-render the updated renderable 3D scene graph to the user interface of the device.

4. The device of claim 3, wherein the second input comprises one or more of: a textual input; a voice input; an image input; a gesture input; a gaze input; a programmatic input; a scene graph file; or a multimedia file input.

5. The device of claim 1, wherein the one or more processors are further configured to execute instructions causing the one or more processors to:
parse the one or more requested attributes from the first input to determine positions within the renderable 3D scene graph wherein one or more 3D components should be added.

6. The device of claim 5, wherein the instructions to add the determined one or more 3D components to the renderable 3D scene graph further comprise instructions causing the one or more processors to:
add the determined one or more 3D components to the renderable 3D scene graph according to the determined positions for the one or more 3D components.

7. The device of claim 1, wherein the first input comprises one or more multimedia assets from a multimedia library, and wherein the one or more 3D components added to the renderable scene graph are determined based on content identified within the one or more multimedia assets.

8. The device of claim 3, wherein the one or more requested modifications to the 3D graphical scene directly identify the at least one 3D component in the renderable 3D scene graph to which the one or more determined modifications are made.

9. The device of claim 1, wherein the instructions to parse the one or more requested attributes from the first input to determine one or more 3D components to add to a renderable 3D scene graph further comprise instructions causing the one or more processors to:
parse the one or more requested attributes from the first input using a trained machine learning (ML)- or artificial intelligence (AI)-based model.

10. The device of claim 9, wherein the trained ML- or AI-based model is configured to be updated over time based, at least in part, on user input to the user interface.

11. The device of claim 1, wherein at least one of the one or more 3D components added to the renderable 3D scene graph comprises a time-varying 3D component having one or more properties configured to change over a duration of time.

12. A non-transitory program storage device comprising instructions stored thereon to cause one or more processors to:
obtain a first input regarding one or more requested attributes of a three-dimensional (3D) graphical scene;
parse the one or more requested attributes from the first input to determine one or more 3D components to add to a renderable 3D scene graph;
add the determined one or more 3D components to the renderable 3D scene graph; and
render the renderable 3D scene graph to a user interface of the device from a first viewpoint.

13. The non-transitory program storage device of claim 12, further comprising instructions stored thereon to cause the one or more processors to:
obtain a second input regarding one or more requested modifications to the 3D graphical scene;
parse the one or more requested modifications from the second input to determine one or more modifications to at least one 3D component in the renderable 3D scene graph;
modify the at least one 3D component in the renderable 3D scene graph according to the determined one or more modifications to update the renderable 3D scene graph; and
re-render the updated renderable 3D scene graph to the user interface.

14. The non-transitory program storage device of claim 12, wherein the first input comprises one or more multimedia assets from a multimedia library, and wherein the one or more 3D components added to the renderable scene graph are determined based on content identified within the one or more multimedia assets.

15. The non-transitory program storage device of claim 12, wherein the instructions to parse the one or more requested attributes from the first input to determine one or more 3D components to add to a renderable 3D scene graph further comprise instructions causing the one or more processors to:
parse the one or more requested attributes from the first input using a trained machine learning (ML)- or artificial intelligence (AI)-based model.

16. The non-transitory program storage device of claim 13, wherein the instructions to modify the at least one 3D component in the renderable 3D scene graph further comprise instructions causing the one or more processors to:
modify an audio characteristic of at least one of the at least one 3D component.

17. An image processing method, comprising:
obtaining a first input regarding one or more requested attributes of a three-dimensional (3D) graphical scene;
parsing the one or more requested attributes from the first input to determine one or more 3D components to add to a renderable 3D scene graph;
adding the determined one or more 3D components to the renderable 3D scene graph; and
rendering the renderable 3D scene graph to a user interface of the device from a first viewpoint.

18. The method of claim 17, wherein the first input comprises one or more of: a textual input; a voice input; an image input; a gesture input; a gaze input; a programmatic input; a scene graph file; or a multimedia file input.

19. The method of claim 17, further comprising:
obtaining a second input regarding one or more requested modifications to the 3D graphical scene;
parsing the one or more requested modifications from the second input to determine one or more modifications to at least one 3D component in the renderable 3D scene graph;
modifying the at least one 3D component in the renderable 3D scene graph according to the determined one or more modifications to update the renderable 3D scene graph; and
re-rendering the updated renderable 3D scene graph to the user interface.

20. The method of claim 17, wherein the first input comprises one or more multimedia assets from a multimedia library, and wherein the one or more 3D components added to the renderable scene graph are determined based on content identified within the one or more multimedia assets.
